(19) United States
(12) Patent Application Publication
(10) Pub. No.: US 2008/0237002 A1
(43) Pub. Date: Oct. 2, 2008

(54) Contact-Type Sensor of Object

(76) Inventor: Zhouxin Zhang, Jiangyin (CN)

Correspondence Address: Daniel J. Hudak;Hudak Shunk & Farine, 2020 Front Street, Suite 307, Cuyahoga Falls, OH, 44221, US

(21) Appl. No.: 10/593,749

(22) PCT Filed: Mar. 25, 2005
(86) PCT No.: PCT/CN2005/000377

§ 371 Date: Sep. 22, 2006

(30) Foreign Application Priority Data
Mar. 26, 2004 (CN) 200410014461.0

(51) Int. Cl. H01H 3/16

(52) U.S. Cl. 200/61.42

(57) ABSTRACT

The present invention relates to a contact-type sensor of an object, which is constructed by placing an elastic light material such as a sponge with certain thickness on the surface of the object and plastic membrane switches which are just like the keyboard of a computer are arranged below the sponge. When a robot equipped with the sensors meets a barrier, the sponge on the surface is pressed and the force can be absorbed by the sponge and transferred to the plastic membrane switches, just as the switches are pressed directly, therefore, the robot can perceive the barrier in one direction.

### TECHNICAL FIELD OF THE INVENTION

The present invention relates to a contact-type sensor of object which is mainly used on electromechanical objects such as a robot to perceive barriers.

### TECHNICAL BACKGROUND OF THE INVENTION

It is commonly necessary for a moving object such as a robot to perceive barriers when it moves. Jiggle switches are often installed on the surface of an object to act as sensors. The spring or reed of a jiggle switch is relatively stiff and the interval of the spring is relatively small, thus, the robot may not stop moving due to inertia after a barrier is perceived. So it is possible that the barrier in the way is impacted, the robot per se is deflected. Due to this reason, ultrasonic or photoelectric non-contact type sensors are commonly used to overcome the above-mentioned problems. However, the cost of an ultrasonic sensor is high and blind zones do exist thereon and jiggle switches are so commonly needed to perform supplementary detection.

### CONTENT OF THE INVENTION

The purpose of this invention is to overcome the above-mentioned deficiencies and provide a contact-type sensor with high pliability and large spring interval. Just like the skin of a person, it is a purpose of this invention to design a cost effective “skin” for a robot which stretches and is capable of perceiving which part of the robot is pressed.

The purpose of this invention is achieved by the design described below. An elastic soft light material such as a sponge with certain thickness is arranged on the surface of a robot on which sensors will be installed; under the sponge, jiggle switches like a computer keyboard which are mechanical, capacitor, conductive plastic or plastic membrane are arranged. When the robot so equipped meets a barrier, the outside surface of the sponge is pressed and the pressure is absorbed by the sponge and transferred to the plastic membrane or other types of jiggle switch arranged on the other side of the sponge, so the jiggle switch is pressed down in this way just as it is pressed down directly. Therefore, the robot can perceive the barrier at one direction. Since the sponge is very soft and able to transfer pressure, when the jiggle switch which is not extremely stiff is used, a contact-type sensor which is collision-proof may be obtained by the combination of the sponge and said jiggle switch. Experiment shows: when an ordinary keyboard is pressed through a sponge arranged at the top thereof, what is first pressed down is the keyboard other than the sponge. The sensors of this invention may be fixed on parts of the surface of the robot which said sensors need to be arranged. The sensor of this invention is simple to make and install, it is reliable and cost effective and may be widely used in moving robots, particularly robot cleaners.

### BRIEF DESCRIPTION OF THE DRAWINGS

FIG. 1 is the longitudinal section view of one shape of the sponge in this invention.

FIG. 2 is one top view of FIG. 1.

FIG. 3 is another top view of FIG. 1.

FIG. 4-FIG. 7 are the partial sectional views of the sponge combined with membrane jiggle switch.

FIG. 8-FIG. 11 are schematic diagrams of the input film, insulating film and output film of a conventional membrane jiggle switch, wherein FIG. 8 shows an insulating film with circular holes in the middle thereof or a input film with conductive contacts but no leads, FIG. 9 shows an insulating film, or an input film or output film with conductive contacts and leads, FIG. 10 or FIG. 11 shows a conventional output film with two separated exposed printed circuits.

FIG. 12-FIG. 14 show the partial sectional views of several sponges having isolating gaps therein combined with membrane jiggle switches.

FIG. 15 is the partial sectional view of a sponge having convexes thereon.

FIG. 16 is the top view of a sponge in this invention.

FIG. 17-FIG. 20 show the longitudinal section views of several different sponges in this invention.

FIG. 21 is the developing drawing of a membrane jiggle switch in this invention.

### EMBODIMENTS TO CARRY OUT THE INVENTION

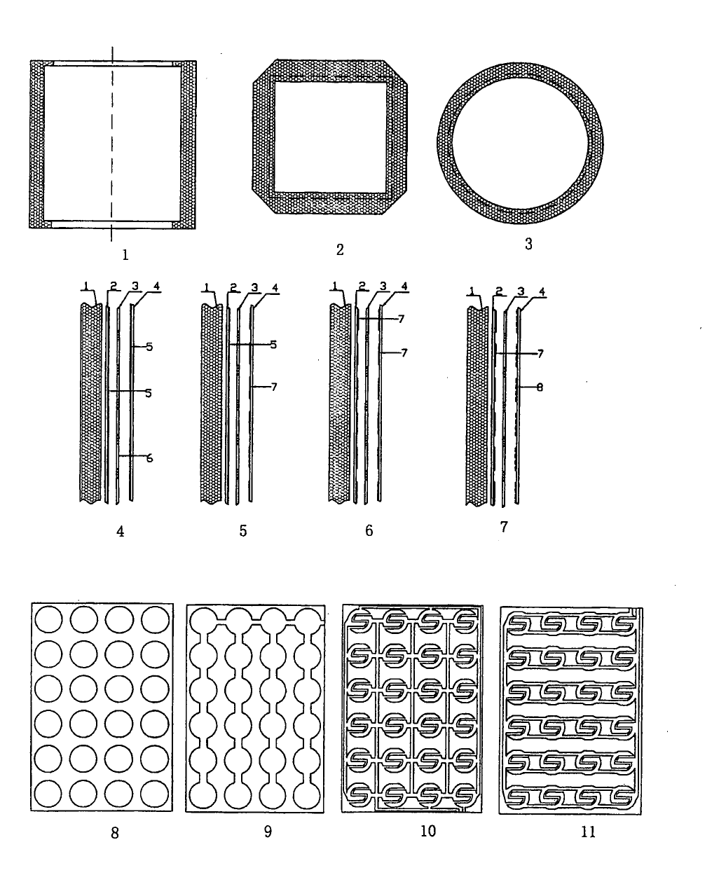

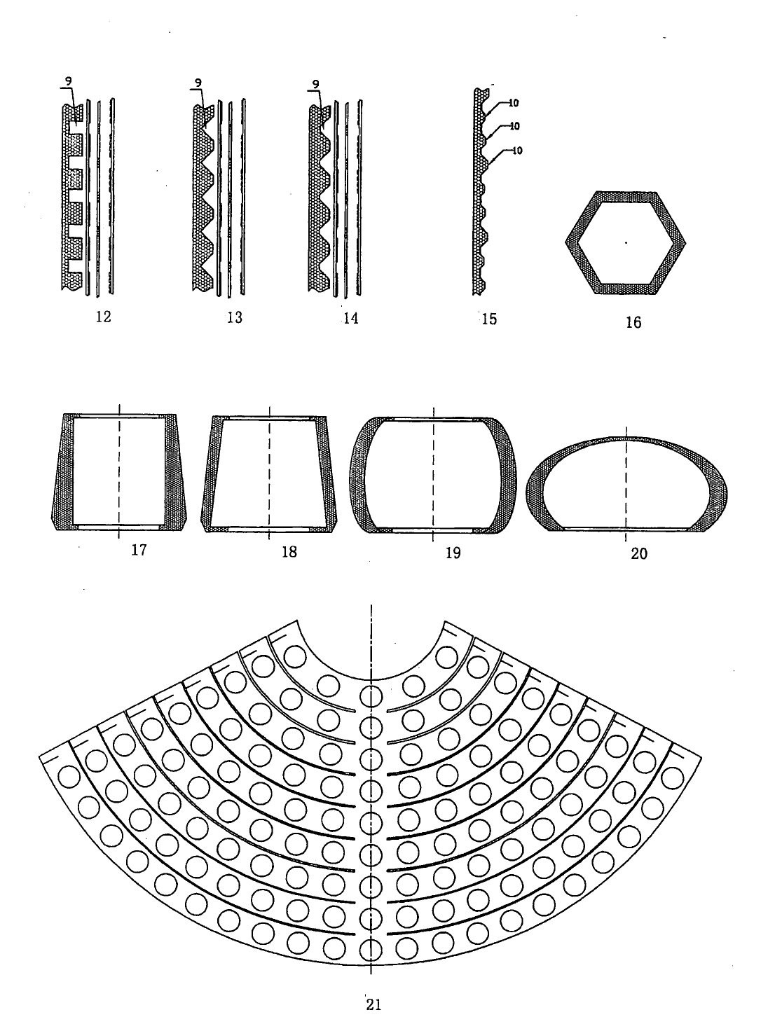

Take low cost sponge and plastic membrane switch as example: said sponge was designed as a plate or hollow cuboid, cylinder, cone or sphere and is arranged at the locations where sensors are required on the surface of a robot and fixed by wrapping or hanging. The sponge may also be wrapped on the surface of the robot by the tension of the sponge per se, as shown in FIG. 1, FIG. 2 and FIG. 3. Under the sponge, three layers of films are arranged, namely input film 2, insulating film 3 and output film 4. Plural through holes 6 are arranged in insulating film 3, which is located between input film 2 and output film 4. The underside of input film 2 and upper side of output film 4 are covered by conductive film 5, as shown in FIG. 4; or contacts 7 are arranged on the underside of input film 2 and the upper side of output film 4 at the locations corresponding to which through holes 6 are arranged in insulating film 3, which is located between input film 2 and output film 4, as shown in FIG. 6; or one of the underside of input film 2 and upper side of the output film 4 is covered with conductive film 5 while the other side of the underside of input film 2 and upper side of output film 4 is arranged with contacts 7 at the locations corresponding to which through holes 6 are arranged in insulating film 3, which is located between input film 2 and output film 4, as shown in FIG. 5. In these examples, each lead is arranged on conductive film 5 or contacts 7 of input film 2 and output film 4. Yet in another example, conductive film 5 having no lead is arranged on the underside of input film 2, or separate contacts 7 are arranged on the underside of input film 2 at the locations corresponding to which through holes 6 are arranged in insulating film 3, which is located between input film 2 and output film 4, and two rows of spaced apart, separate and exposed printed circuit contacts 8 are arranged on the upper side of output film 4 at the locations corresponding to which through holes 6 are arranged in insulating film 3, which is located between input film 2 and output film 4, as shown in FIG. 7. The aforesaid conductive film 5 or contacts 7 may be metal material or conductive plastic or other films formed of other conductive substances. Conductive film 5 may also be a metal film, such as aluminum foil. Input film 2 and output film 4 may all be metal films. Generally, the leads between the contacts of input film 2 and output film 4 are printed circuits. Also, a mechanical, capacitor or conductive plastic jiggle switch like a computer keyboard may be arranged under the sponge. When the robot so equipped meets a barrier, the outside surface of the sponge is pressed and the pressure is absorbed by the sponge and transferred to the plastic membrane or other types of jiggle switch arranged on the other side of the sponge, so the jiggle switch is pressed down in this way just as it is pressed down directly. Therefore, the robot may perceive the barrier at one direction.

The output of a switch is generally low level when it is connected but high level when disconnected. Therefore, if there is a lead from the input film, as shown in FIG. 4-FIG. 6, the lead is generally connected to a low level, i.e. logic ground, while the lead of the output film is connected to a logic circuit or a Single Chip Micyoco (SCM). By referring to FIG. 7, there is no lead from the input film; one of the two rows of printed circuits of the output film is connected to a low level while the other is connected to a logic circuit or SCM.

In certain circumstances where it is required to know the precise location at which the robot meets a barrier in one direction, plural signal outputs may be considered instead of only one signal output. Just as the keys of a computer keyboard or some other electronic devices, plural jiggle switches which are separated from each other may be arranged under sponge 1, which is arranged on one or several surfaces of the robot. Also, separating gaps 9 which are vertical to the surface of the switches may be created in the sponge, as shown in FIG. 12-FIG. 14, or by using multiple separate sponges to avoid misoperation of adjacent switches when the sponge at one location is pressed down.

Input film 2 of this invention is generally referred to the film which is covered with conductive film 5 or arranged with contacts 7 and only low level or high level (low level often) is input thereto. Output film 4 is referred to the film from which the signal of the change of state of the switch is output, but it is not always the case. Where plural separate jiggle switches are arranged at one direction, for the convenience of wiring, signal output wiring may be arranged on input film 2 while signal input wiring may be arranged on output film 4. Insulating film 3 functions to insulate the contacts or circuits of input film 2 and output film 4 under normal state, i.e. no pressure on the films. One of input film 2 and output film 4 may be integral with sponge 1, or sponge 1 which is conductive may even be used as the film. One of input film 2 and output film 4 may be integral with the surface of an object, for example, the surface of the object may be directly a Printed Circuit Board (PCB) or formed of metal. Input film 2 is generally arranged on insulating film 3 and output film 4 is arranged below insulating film 3, or vice versa. Take FIG. 7 as an example, since more printed circuits are arranged on output film 4, if arranged below sponge 1 and pressed accordingly, the printed circuits may be deformed at some locations and the reliability thereof may be affected. Thus, output film 4 is generally arranged on the surface of the object while input film 2 having contacts only is arranged below sponge 1.

Sponge 1 may be fixed by wrapping, hanging or sticking on the jiggle switches. For the accuracy and tight of the wrapping of the sponge, attachment clips or set screws which are not in close coordination with the sponge are arranged via said sensors on the surface of the object. Input film 2, insulating film 3 and output film 4 may be fixed by hanging, sticking or adhering or fixed by clips or screws to the surface of the object. The wiring of signal input or signal output of input film 2 or output film 3 may be twisted and arranged along the rims of input film 2 and output film 4, or fixed to, adhered to or pressed into input film 2 or output film 4, or fixed by conductive plastic and then drawn out. The fixing of the membrane jiggle switch, arrangement of the wiring of signal and the pulling out thereof is just as that of the membrane keyboard which is well known to the art, so it will not be described herein in detail. In all the exemplary figures, through holes 6 or contacts 7 are conventionally circular. Of course, said holes or contacts may also be rectangular or other shapes.

The outside surface of sponge 1 per se or additional wrapping materials may be designed to varieties of shapes which are human-based, such as cartoons. Colors or characters may also be printed on said outside surface to make it more attractive. To avoid sponge 1 impacting directly with outside sharp corners and becoming worn or damaged, a film may be attached to the outside surface of sponge 1 or some materials may be wrapped thereon. By doing so, the friction between the pressed sponge and the barrier is also decreased. In another example, Membrane jiggle switches may even be wrapped on the sponge to replace the film which is attached to the outside surface of the sponge. Where the input film is formed of metal, it wraps the surface of the robot completely. To be more attractive, patterns or characters may be attached or printed on the surface of the said input film. If the said input film is grounded, it is anti-jamming and anti-electromagnetic shielding. At the locations where other types of sensors or charging metal strips, cooling or exhaustion holes are to be arranged, a certain number of windows may be opened at the corresponding places in the sponge and membrane jiggle switches, or just put the things described as above on the top or at the bottom of the robot where no sponge is arranged. The thickness of the sponge is designed as a bit larger than the shortest one-step distance of the robot so that said robot can be stopped in a timely manner once a barrier is perceived. In one example, a certain area of sponge impacts directly with a large barrier, such as a wall, the resistance is relatively high and so affects to movement of the walking structure and correct orientation of the robot. In this case, the shape of the sponge and the jiggle switches as a whole which are arranged on the surface of the object may be changed, for example, the sponge and the jiggle switches as a whole which are arranged on the surface of the object may be designed as spherical, circular truncated cone, cone, trapeziform or polyhedral cylinder or the like, as shown in FIG. 16˜20 to decrease the contact area of the surface of the object and the barrier. The outside surface of the sponge may be lifted at some locations, or the locations of the sponge with which the jiggle switches contact may be formed to convexes and some of the convexes contact loosely with the switches, some of the convexes depart from the switches a certain distance and the others depart even further, as shown in FIG. 15. A layer of sponge grid cushion may even be arranged between said contact-type sensors and the surface of the object. The cushion may be of any shape so far as it is easy to make, simple to arrange and capable of being an insulator. When the sensors are pressed, the sponge cushion described as above deforms first. Of course, additional switches may be arranged between the said sponge cushion and the contact-type sensors to get a better performance—it is just like two layers of contact-type sensors work together back to back. The sponge may also be formed into plural layers, one of which is sponge grid; membrane jiggle switches may be arranged between the layers. For example, the sponge is comprised of two layers of sponge grids, membrane switches are arranged therebetween, or hollows may be formed in the middle of the sponges. The sponge may be the wave type and the wave-type convexes thereon could be less. With regard to the sponge arranged at the locations where pressure continues to exist, a high spring sponge may be applied. In this case, cavities should be prepared at some certain places so that the pressed sponge can spring therein. For example, the contact-type sensors of this invention, which are installed downward at the bottom of the robot to detect and prevent the robot from falling, may be pressed for a long time when it stays stationary or moves. For the purpose of avoiding that the sponge could not spring due to the continuous pressure, several cavities may be arranged in the charging seat of the robot so that the downward contact-type sensors could spring sufficiently in the cavities described as above. At the same time, such cavities may also be used to function as a supplementary positioning mechanism to locate the robot at desired places.

Input film 2, insulating film 3 and output film 4 of the membrane switches which are installed on the surface of an object may be attached thereto by gore method, i.e. the developing drawing which is drawn by developing method of parallel lines, the developing drawing of the surface of a cylindrical object is simple and substantially rectangular, as shown in FIG. 9. The developing drawing of a cone is much more complicated. FIG. 21 shows a frustoconical membrane switch after cutting. As to a sphere or a circular truncated cone, the developing drawing thereof could not be a plane and may be basically interpreted as the aggregate of plural of frustocones and be developed similarly as a frustocone. At each end of the each developing drawing described hereinabove, a pair of slots are arranged which are in opposite directions to ensure that each developing drawing can be connected with each other on the sphere or frustocone.

The present invention is mainly installed on a robot for perceiving barriers but it is not intended that this invention is just limited thereto. The present invention may also be used in the conventional keyboard of a computer or some other electronic devices in which the springs or protruding elastic rubber pads may be replaced by cost-effective sponge; the sponge may be covered with wear resistant, soft plastic membrane on which the name of the key is indicated, or on the surface of the sponge, character-shaped convexes or concaves may be formed directly so as to decrease the cost and the weight of the keys or the keyboard and improve the comfort of the hands when said keys are pressed. Since the sponge is not wear resistant but of low cost, additional sponges may be prepared as spare parts.

1. A contact-type sensor of an object, comprising: a sponge, and at least one jiggle switch arranged thereunder, said jiggle switch is selected from the group consisting of membrane jiggle switches, mechanical jiggle switches, conductive plastic jiggle switches and capacitor jiggle switches.

2. The contact-type sensor of an object of claim 1, wherein said membrane jiggle switch is comprised of three layers of films, namely an input film, an insulating film and an output film, and wherein through holes are arranged in the said insulating film which is arranged between said input film and said output film.

3. The contact-type sensor of an object of claim 2, wherein a conductive film covers each surface of the input film and output film facing said insulating film.

4. The contact-type sensor of an object of claim 2, wherein contacts are arranged on each surface of the input film and the output film facing the insulating film at the locations corresponding to which said through holes are arranged in the insulating film.

5. The contact-type sensor of an object of claim 2, wherein a conductive film is attached to one of the surfaces of the input film and the output film facing the insulating film, and wherein contacts are arranged on the other surface of the input film and output film facing the insulating film at the locations corresponding to which said through holes are arranged in the insulating film.

6. The contact-type sensor of an object of claim 2, wherein the input film is arranged under the sponge, wherein an underside of the input film is covered by conductive film or arranged with contacts at the locations corresponding to which the said through holes are arranged in the insulating film, and wherein two rows of spaced apart, separate, exposed printed circuit contacts are arranged on the upper side of the output film at the locations corresponding to which said through holes are arranged in the insulating film.

7. The contact-type sensor of an object of claim 2, wherein one of the input film and the output film are integral with the sponge to obtain a conductive sponge.

8. The contact-type sensor of an object of claim 2, wherein one of the input film and output film are integral with the surface of the object.

9. The contact-type sensor of an object of claim 2, wherein said input film and output film are metal films.
